(19) United States
(12) Patent Application Publication
(10) Pub. No.: US 2023/0248595 A1
(43) Pub. Date: Aug. 10, 2023

(54) A Seat

(71) Applicant: Rolapal Limited, Auckland (NZ)

(72) Inventor: Roydon Mark Scarlett, Auckland (NZ)

(21) Appl. No.: 18/012,745

(22) PCT Filed: May 11, 2021
(86) PCT No.: PCT/NZ2021/050082

§ 371 Date: Dec. 23, 2022

(30) Foreign Application Priority Data
Jul. 13, 2020 (NZ) 766176

(51) Int. Cl. A61G 5/10

(52) U.S. Cl. CPC A61G 5/1075

(57) ABSTRACT

It is known to provide a seat for disabled users with postural care needs where the incline of the seat is adjustable. A problem with such seats is that the incline adjustment mechanism is not particularly smooth or easy to use. To address this, there is a seat having a backrest, a base for receiving the posterior of a human user and an incline adjuster. The incline adjuster has an unevenly curved track 6 and at least a pair of spaced brackets 27 each supporting rollers 16. The incline adjuster is adapted to be activated so that at least one of the brackets 27 is able to tilt with respect to the other while the track 6 runs on the rollers 16 and the brackets are at differently curved parts of the track, to adjust the incline of the backrest and base.

### FIELD OF INVENTION

This invention relates to a seat, for example for users with special postural care requirements.

### BACKGROUND

It is known to provide a seat for disabled users with specific postural care needs where the incline of the seat is adjustable. A problem with such seats is that the incline adjustment mechanism is not particularly smooth or easy to use.

### OBJECT

It is an object of preferred embodiments of the present invention to go at least some way towards addressing the above problem. While this applies to preferred embodiments, the object of the invention per se is not so limited. It is simply to provide a useful choice. Therefore any objects or advantages applicable to preferred embodiments should not be seen as limitations on claims expressed more broadly.

### DEFINITIONS

The terms “comprise” and “have”, if and when used in relation to a combination of features should not be taken as excluding the possibility of the combination having other features that are not mentioned. The same applies to derivatives of these words, for example “comprising” and “having”.

### SUMMARY OF INVENTION

According to one aspect of the invention there is provided a seat comprising:
a backrest;
a base for receiving the posterior of a human user; and
an incline adjuster having:
   an unevenly curved track; and
   at least a pair of spaced brackets each supporting rollers, characterised in that the incline adjuster can be activated so that at least one of the brackets is able to tilt with respect to the other while the track runs on the rollers and the brackets are at differently curved parts of the track, to adjust the incline of the backrest and base.

Optionally the track and brackets are at one side of the seat and a second substantially identical track and at least a second pair of substantially identical brackets are at an opposite side of the seat, arranged so that the track and brackets at each side function with respect to one another substantially the same way.

Optionally each track comprises a curved rail.

Optionally each bracket has a set or two, three or four of the rollers and all the rollers of each set engage the track.

Optionally the track has curvature in the form of at least two radial arcs.

### BRIEF DESCRIPTION OF THE DRAWINGS

Some preferred forms of the invention will now be described by way of example and with reference to the accompanying drawings, of which:

FIG. 1 is an isometric view of a seat;

FIG. 2 is a side view of an angle adjuster;

FIG. 3 is a partially cut away side view of the angle adjuster;

FIG. 4 is an isometric view of a tilt rail;

FIG. 5 is a side view showing detail of components of an alternative seat;

FIG. 6 is a side view of some components of a wheelchair;

FIG. 7 is a side view showing detail of components of the wheelchair;

FIG. 8 is also side view showing detail of components of the wheelchair; and

FIG. 9 is a cross sectional side view showing detail of components of the wheelchair.

### DETAILED DESCRIPTION

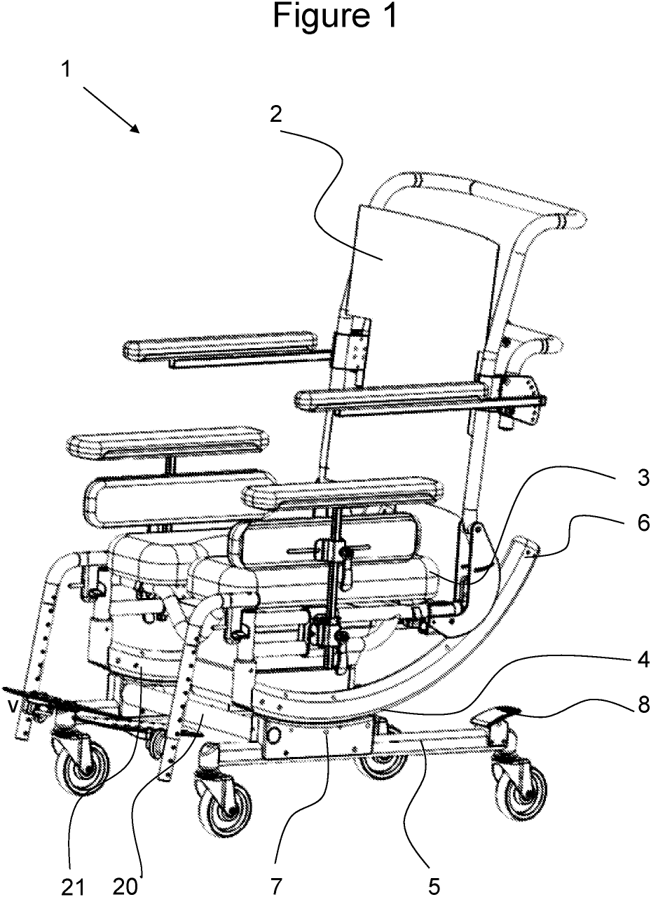

Referring to FIG. 1, in a preferred embodiment of the invention a seat 1 comprises a backrest 2, a base 3 for a user to sit on and an incline adjuster 4. In this example the seat is a commode, but in other embodiments the invention may be in a different form, for example it may be a wheelchair or some other form of disability seat.

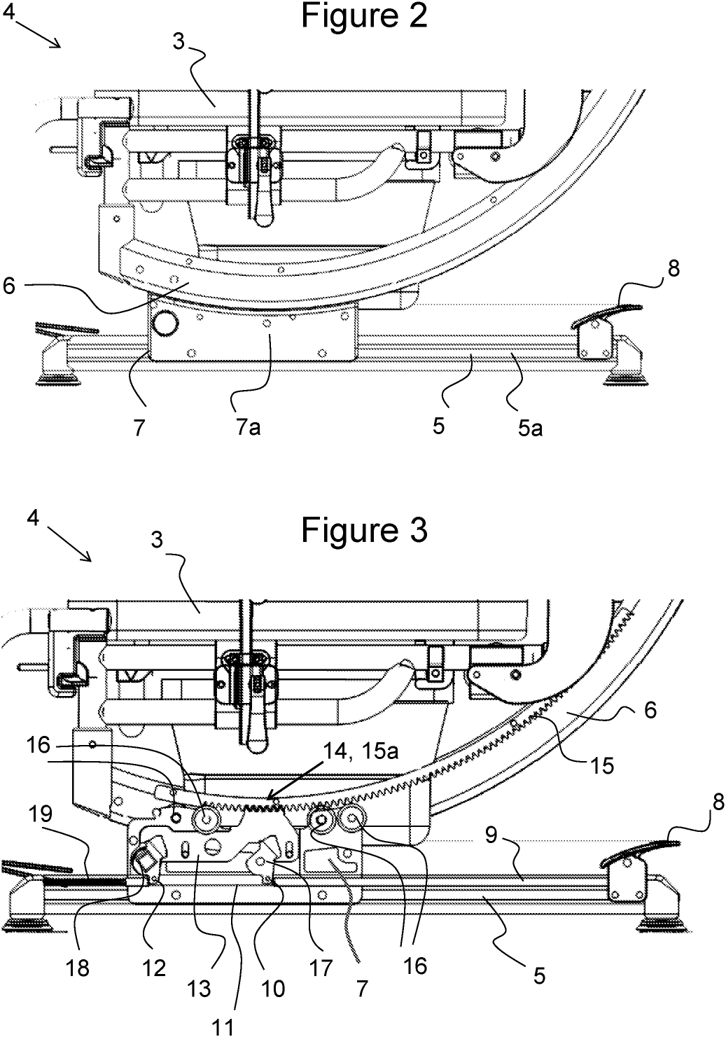

FIG. 2 shows the seat when the internal parts of the incline adjuster 4 are concealed, and FIG. 3 when they are exposed. The incline adjuster 4 has a support or chassis base 5, a curved tilt rail 6, a roller mount 7 and a foot-operated pedal 8. The pedal 8 is connected to a tilt rod 9 (see FIG. 3) that in turn connects to a lever or tilt lock cam 10. A connector rod (not shown) lies in the space 11 to connect the cam 10 and a second lever or tilt lock cam 12.

Each cam 10, 12 is in contact with a tilt lock follower 13. The rail 6 is preferably tubular and has a curved rack 15 enclosed within the rail 6. The follower 13 has a plurality of teeth 14 that mesh with corresponding teeth 15a of the rack 15.

The roller mount 7 is positioned on the chassis base 5 and has four pairs of rollers 16 near its top. In some embodiments the rollers may be in the form of castors.

When the teeth 14 of the follower 13 are engaged with the teeth 15a of the rack 15, the adjuster 4 is in a locked disposition. The rail 6 cannot move and the backrest 2 and base 3, which are connected to the rail 6, are in a fixed position.

To adjust the angle of the backrest 2 and base 3, the user steps on the pedal 8 which causes the rod 9 to move from right to left. This in turn causes the rod 9 to push against a lower part of the cam 10, which in turn causes the cam 10 to move clockwise about a pivot point 17. The upper part of the cam 10 engages the follower 13 as it turns.

The movement of the rod 9 also urges the connector rod (not shown, but it lays in the space 11) into the second cam 12, which causes that cam 12 to also move clockwise about a second pivot point 18 into a further part of the follower 13. The connector rod compresses a spring 19 which remains under pressure while the pedal 8 is depressed.

As the cams 10, 12 turn clockwise they move the follower 13 down so that the teeth 14 disengage from the rack teeth 15a. The rail 6 is then free to run back and forwards over the rollers 16.

When unlocked, the user can move the rail 6 manually to adjust the amount of incline of the backrest 2 and base 3. When the desired angle is reached, the user steps off the pedal 8, which releases pressure on the spring 19. This moves the connector rod and the rod 9 from left to right, and turns the cams 10, 12 counter-clockwise. The result is that the teeth 14 reengage with the teeth 15a, thereby locking the rail 6 with respect to the mount 7.

Referring back to FIG. 1, a cross member or bar 20, extends from the second pivot point 18 to connect with a second incline adjuster. The second adjuster comprises a second similar or identical roller mount and locking mechanism (not shown in FIG. 1) and a second identical tilt rail 21 on the other side of the seat 1. When the first mentioned adjuster 4 is operated, the second adjuster moves in unison with it. The two are constructed the same, or substantially the same; both locked or released in response to the pedal 8 being depressed and released.

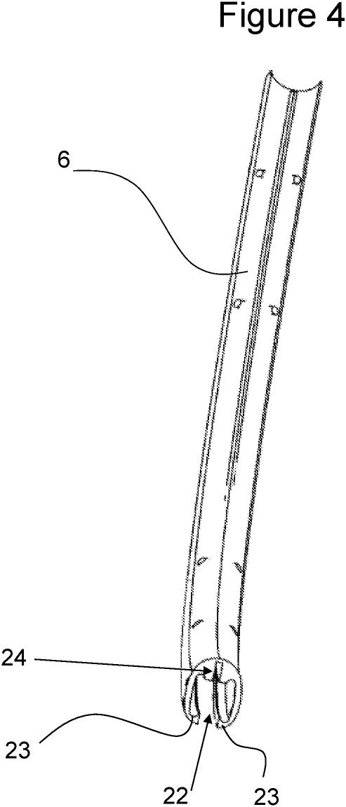

FIG. 4 shows a cross section of the rail 6 without the rack 15 that would normally be inside it. The underside of the rail 6 has an opening 22 to accommodate the mount 7 when the seat 1 is assembled. Each pair of rollers 16 runs along grooves 23 on opposite sides of the opening 22. A slot 24 is sized to receive the rack 15 and teeth 15a which are able to engage and disengage with the follower teeth 14.

Referring back to FIGS. 2 and 3, the rod 9 and spring 19 are housed within a chassis base panel 5a, and the mount 7 is housed within a mount panel 7a. As indicated above, the rack 15 is housed within the rail 6. The follower 13, while attached to the mount 7, extends partly into the rail 6 when the follower teeth 14 engage the rack teeth 15a. Again, the rollers 16 are housed within the rail 6 along the grooves. The moving parts of the adjuster 4 are therefore substantially enclosed when the seat 1 is assembled and used. This assists in protecting the parts from dirt, moisture, spillage of bodily fluids and various other contaminants that may damage or otherwise compromise exposed parts. This also addresses the risk of a user’s fingers being accidentally caught in moving parts when the incline of the seat 1 is being adjusted.

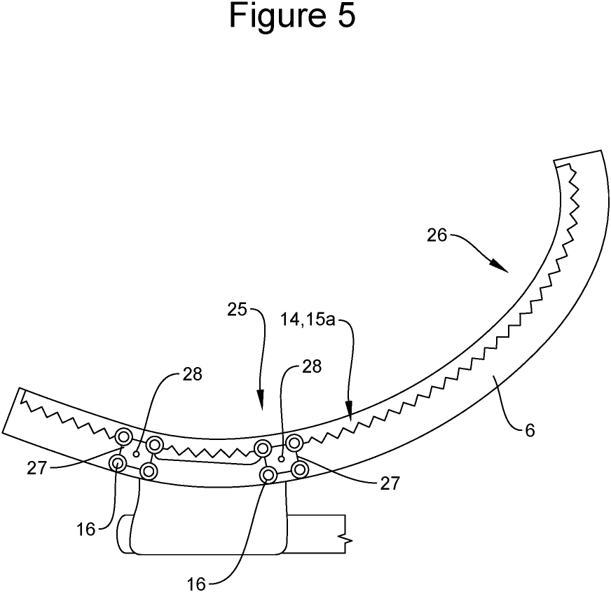

In some embodiments of the invention the rails 6 may be unevenly curved. For example the curvature of each rail 6 may involve the merger of arcs that have a different radius. This is illustrated in FIG. 5 where the arc of the rail is based on a larger radial curve 25 that runs into a smaller radial curve 26. The embodiment in FIG. 5 is a wheelchair, but in principle the parts function the same or substantially the same way described above. However because of the changing curvature, the arrangement of the rollers 16 is modified. As indicated, at each side of the seat the rollers are divided into two sets of four. The rollers of each set are able to rotate as normal so that the rail 6 can run smoothly over them. But in this case the rollers 16 of each set are journaled on a respective separate bracket 27 and each bracket is able to pivot about a respective pivot point 28. This means that one bracket 27, and therefore its rollers 16, can be tilted at a different angle to the other bracket and rollers. This is useful because at various times, one of the sets of rollers will be at a tighter curved part of the rail 6 than the other. The arrangement enables each bracket 27 to tilt back and forth and stops the rail 6 from jamming on the rollers. It accordingly facilitates smooth adjustment of the incline of the seat.

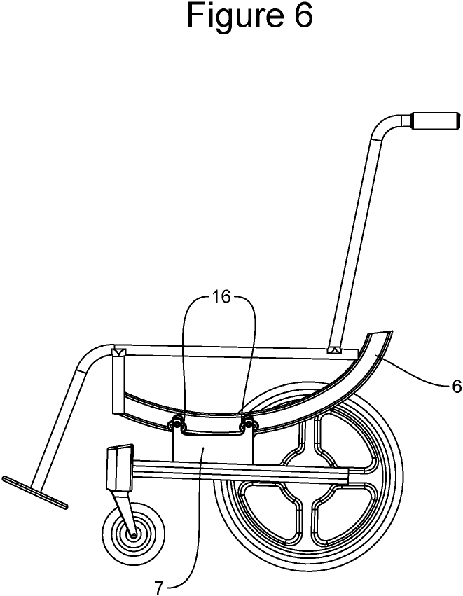

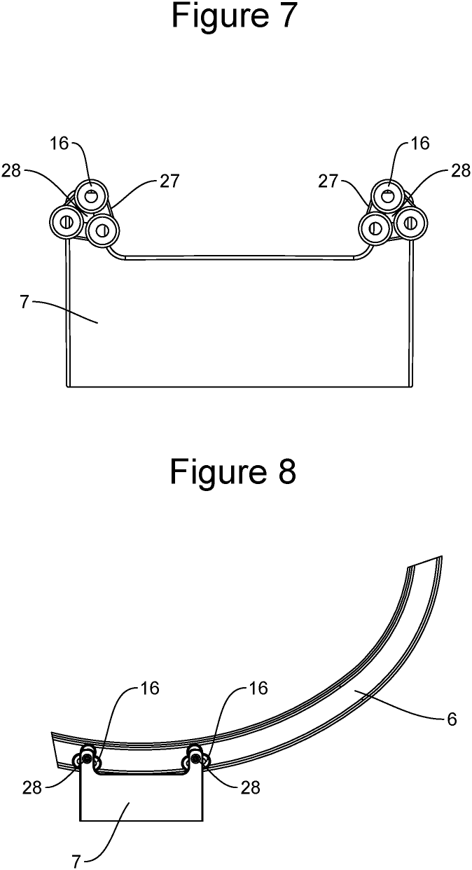

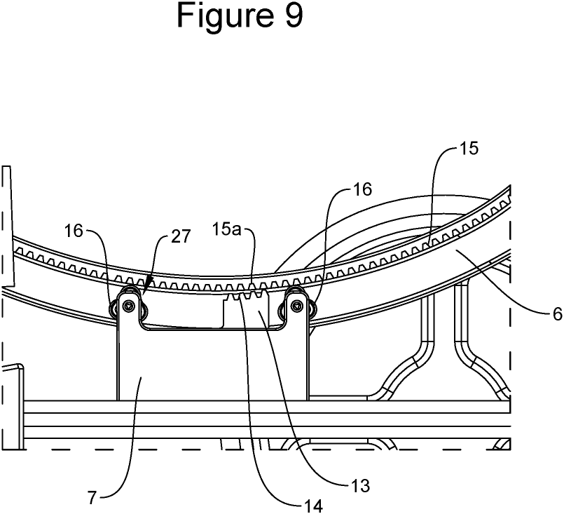

FIG. 6 illustrates an embodiment the same as mentioned for FIG. 5, except that each set of rollers has only three rollers 16, arranged in a triangular fashion. FIGS. 7 and 8 illustrate some components of the FIG. 6 embodiment where like reference numbers are used to designate like parts. FIG. 9 illustrates the manner in which the teeth 14 of the FIG. 6 follower 13 engage with the teeth 15a of the rack 15. FIGS. 6-9 omit certain features for ease of viewing, but preferably the other components are the same or substantially the same as described for any of the other embodiments above. The mechanism described in FIGS. 5-9 is preferably the same for both sides of the seat.

In terms of disclosure, this document hereby envisages each item, feature or step mentioned herein, in combination with one or more of any same or other item, feature or step disclosed herein, in each case regardless of whether the combination is claimed.

While some preferred forms of the invention have been described by way of example it should be appreciated that modifications and improvements can occur without departing from the scope of the appended claims.

1. A seat comprising:
a backrest;
a base for receiving the posterior of a human user; and
an incline adjuster having:
an unevenly curved track; and
at least a pair of spaced brackets each supporting rollers,
the incline adjuster adapted to be activated so that at least one of the brackets is able to tilt with respect to the other while the track runs on the rollers and the brackets are at differently curved parts of the track, to adjust the incline of the backrest and base.

2. A seat according to claim 1, wherein the track and brackets are at one side of the seat, and a second substantially identical track and at least a second pair of substantially identical brackets are at an opposite side of the seat, arranged so that the track and brackets at each side function with respect to one another substantially the same way.

3. A seat according to claim 1 wherein the track, comprises a curved rail.

4. A seat according to claim 1, wherein each bracket has a set or two, three or four of the rollers and all the rollers of each set engage the track.

5. A seat according to claim 1, wherein the track has curvature in the form of at least two radial arcs.

6. A seat according to claim 5, forming part of a commode.

7. A seat according to claim 5, forming part of a wheelchair.

8. (canceled)

9. (canceled)

10. A seat according to claim 1, in the form of a wheelchair or commode, wherein:
the track and brackets are at one side of the seat, and a second substantially identical track and at least a second pair of substantially identical brackets are at an opposite side of the seat, arranged so that the track and brackets at each side function with respect to one another substantially the same way;
each track comprises a curved rail.
each bracket has a set or two, three or four of the rollers and all the rollers of each set engage the track.
the track has curvature in the form of at least two radial arcs.

11. A seat according to claim 2, wherein each track comprises a curved rail.

12. A seat according to claim 2, wherein each bracket has a set or two, three or four of the rollers and all the rollers of each set engage the track.

13. A seat according to claim 3, wherein each bracket has a set or two, three or four of the rollers and all the rollers of each set engage the track.
